(19) United States
(12) Patent Application Publication
(10) Pub. No.: US 2019/0107629 A1
(43) Pub. Date: Apr. 11, 2019

(54) DELIVERY OF PRECISE TIME TO GPS RECEIVERS IN AN ON-BOARD UNIT OVER DEDICATED SHORT RANGE COMMUNICATIONS OR C-V2X AND WAY IN DSRC CONNECTED VEHICLE NETWORK TO ENHANCE OBE GPS PERFORMANCE

(71) Applicant: Panasonic Automotive Systems Company of America, Division of Panasonic Corporation of North America, PEACHTREE CITY, GA (US)

(72) Inventors: SAMEH WILLIAM TAWADROUS, SENOIA, GA (US); HANS A. TROEMEL, JR., SHARPSBURG, GA (US)

(73) Assignee: Panasonic Automotive Systems Company of America, Division of Panasonic Corporation of North America

(21) Appl. No.: 16/052,794

(22) Filed: Aug. 2, 2018

Related U.S. Application Data
(60) Provisional application No. 62/568,365, filed on Oct. 5, 2017.

(51) Int. Cl. G01S 19/25; G01S 19/35; G01S 19/05

(52) U.S. Cl. CPC G01S 19/25; G01S 19/05; G01S 19/35

(57) ABSTRACT

On-board equipment for a motor vehicle includes a DSRC radio receiving a signal from road side equipment. The signal has an accurate frequency in accordance with GPS time. A GPS receiver is communicatively coupled to the DSRC radio. The on-board equipment determines the GPS accurate time and provides the GPS accurate time to the GPS receiver. The determining of the GPS accurate time is dependent upon the accurate frequency in the signal.

### CROSS-REFERENCED TO RELATED APPLICATIONS

This application claims benefit of U.S. Provisional Application No. 62/568,365 filed on Oct. 5, 2017, which the disclosure of which is hereby incorporated by reference in its entirety for all purposes.

### FIELD OF THE INVENTION

The disclosure relates to an on-hoard unit of a dedicated short-range communication system in a motor vehicle, and, more particularly, to providing precise time to an on-board unit of a dedicated short range communication system in a motor vehicle.

### BACKGROUND OF THE INVENTION

Dedicated short-range communications (DSRC) are one-way or two-way short-range to medium-range wireless communication channels specifically designed for automotive use and a corresponding set of protocols and standards. A road side unit (RSU) is the part of a DSRC system that is installed on the side of the road.

Road Side Equipment (RSE) includes the RSU in addition to other equipment to link the RSU to a backend network that may be hosted in the cloud. An on-board unit (OBU) is the part of a DSRC system that is installed in the moving vehicle.

On Board Equipment (OBE) may be the part of network that is installed in the car. On-board equipment may include other equipment in addition to the OBU, such as a human-machine interface unit and other communication equipment in the car.

After a vehicle loses track of its GPS location, the time required to re-establish the GPS location, which may be referred to as the time to first fix (TTFF), may be several minutes. This period of time may be unacceptably long for safety applications wherein the driver loses full benefit of safety features while the vehicle's GPS location is unknown.

It is exceedingly difficult for the OBU to get a GPS fix in urban canyon environment due to further weakened GPS satellites signal specially is case where GPS aiding parameter are not available.

### SUMMARY

The present invention may provide precise GPS time and other aiding parameter to OBE over the DSRC network or the C-V2X network by utilizing information obtained by the backend network and/or the GPS receiver in the RSE. After GPS receiver in the RSU has obtained a position fix, the GPS receiver may be able to provide accurate time to the DSRC modem or the C-V2X modem, which in turn can modify its own transmitter frequency to reflect accurate time. All OBUs in the coverage area of the RSE may in turn be able to modify their frequency and time settings to sync up to the RSE frequency. The OBU DSRC or C-V2X may also provide the precise time to the GPS receiver within the OBE. This is one method to deliver GPS time to the OBU over the DSRC network or the C-V2X network.

Utilizing further information obtained by the GPS receiver in the RSU, Almanac, Ephemeris and approximate position details may also be delivered to the OBU over the DSRC network via DSRC messaging protocol, or over the C-V2X network via C-V2X messaging protocol.

One more way to obtain almanac and Ephemeris information is utilizing the RSE access to the backend network where this information may be available.

This disclosure may describe delivery of accurate time almanac, Ephemeris and approximate position through the RSU as well as describe a way to obtain GPS aiding parameters from the GPS receiver in the RSE.

The invention may address delivery of accurate time over the DSRC or C-V2X communication channel. Accurate time is a parameter that is needed in addition to Almanac, Ephemeris and approximate position in order for the GPS receiver in the OBU to calculate its position faster. The time needed to calculate a position fix knowing GPS accurate time, Almanac and Ephemeris is seconds in good signal conditions. However, without accurate time, Almanac and Ephemeris it would take minutes. Knowing Almanac, updated Ephemeris, approximate position and accurate time yields Faster TTFF, an accurate position estimate and a more sensitive receiver. A more sensitive receiver enables the GPS receiver in the OBU in the car to utilize a weaker satellite signals to calculate its position. Otherwise the GPS receiver would fail in calculating a fix with a less sensitive receiver. Accurate time may be obtained through the GPS receiver in the RSU. Accurate time may be obtained once the GPS receiver in the RSU is able to calculate a fix. Then, accurate time may be communicated to the OBU over the wireless physical channel using the DSRC communicator residing in the RSU and OBU. The DSRC communicator in the OBU then passes accurate time to the GPS receiver.

The invention may provide aiding information to OBU equipment over the DSRC network by utilizing information obtained by the backend network and utilizing the knowledge of the known RSE location.

By providing an aiding parameter, the GPS receiver residing in the OBE equipment can obtain a GPS fix at a much lower signal strength. Also, by providing aiding parameters, the GPS may be able to calculate a position fix in a significantly shorter time with more accuracy. This aiding information can be obtained by the backend network that is connected to the RSE, and hence the RSE can pass the aiding information through to the OBE over the DSRC physical channel. The aiding parameter may include the approximate location and the elevation of position of the GPS receiver, which can be approximated by the RSE location, and which is a position known by the backend network.

One example of a way to implement the solution of the invention is for the backend network to obtain Ephemeris, updated GPS almanac, approximate position and elevation in addition to GPS time obtained by the RSE GPS receiver and provide them to OBU through RSE. Ephemeris can be tailored and optimized by limiting its contents to only visible satellites in the area of each individual RSE based on the known individual RSE location. Also, the Ephemeris optimization can be done in the RSE. In turn, RSE may transmit the optimized Ephemeris, up-to-date GPS almanac, approximate position and elevation and GPS time to all OBE in the coverage area of the local RSE.

The invention may address Almanac update, Ephemeris and approximate position delivery from the RSU to the OBU. Since the RSU has a connection to the backbone network, the RSU may have access to all Almanac updates and up-to-the minutes Ephemeris updates. The RSU knows its precise location. Those parameters can be delivered to all OBUs within the RSU's radius of communication over the wireless channel using the DSRC communicator. In turn, the DSRC communicator in the OBU can share that information to the GPS receiver built in each OBU. The precise location of the RSU becomes the approximate location of the GPS receiver in the OBU. The GPS receiver in the OBU can make use of that information to calculate a better and faster position fix of the OBU and hence of the motor vehicle in which the OBU is installed.

In one embodiment, the invention comprises on-board equipment for a motor vehicle. The on-board equipment includes a DSRC radio receiving a signal from road side equipment. The signal has an accurate frequency in accordance with GPS time. A GPS receiver is communicatively coupled to the DSRC radio. The on-board equipment determines the GPS accurate time and provides the GPS accurate time to the GPS receiver. The determining of the GPS accurate time is dependent upon the accurate frequency in the signal.

In another embodiment, the invention comprises a method of operating on-board equipment in a motor vehicle, including providing the on-board equipment with an on-board unit including a DSRC radio and a GPS receiver. The DSRC radio receives a signal from road side equipment. The signal has an accurate frequency in accordance with GPS time. The on-board unit establishes a frequency of the on-board unit in accordance with the signal. A GPS accurate time is determined within the on-board equipment. The GPS accurate time is dependent upon the established frequency of the on-board unit. The GPS accurate time is provided to the GPS receiver.

In yet another embodiment, the invention includes an arrangement for providing GPS accurate time in a motor vehicle. The arrangement includes road side equipment having a road side unit. The road side unit includes a first GPS receiver producing GPS accurate time. A first DSRC radio is communicatively coupled to the first GPS receiver. The road side unit establishes a frequency of the road side unit in accordance with the GPS accurate time. The road side equipment transmits a signal including an accurate frequency. The accurate frequency is dependent upon the established frequency of the road side unit. On-board equipment includes a second DSRC radio receiving the signal from the road side equipment. A second GPS receiver is communicatively coupled to the second DSRC radio. The on-board equipment determines the GPS accurate time and provides the GPS accurate time to the second GPS receiver. The determining of the GPS accurate time is dependent upon the accurate frequency in the signal.

In still another embodiment, the invention includes on-board equipment for a motor vehicle having a DSRC radio receiving a signal from road side equipment. The signal has accurate GPS location information. A GPS receiver is communicatively coupled to the DSRC radio. The on-board equipment determines approximate location and it to the GPS receiver. The determining of the accurate GPS location is dependent upon the accurate GPS location information in the signal.

In a still further embodiment, an arrangement for providing approximate location in a motor vehicle includes a backend network transmitting first location information. A road side unit is communicatively coupled to the backend network. The road side unit transmits road side unit identification information information to the backend network. The road side unit transmits second accurate GPS location information based on the backend communication. An on-board unit is communicatively coupled to the road side unit and receives the second accurate GPS location information. The on-board unit determines an accurate GPS location dependent upon the second accurate GPS location information.

An advantage of the present invention is that it may reduce the time to first fix (TTFF) a GPS location from minutes to seconds.

Another advantage is that the OBE included in coverage area of the RSE may be enabled to obtain a fix at a much lower satellite signal and faster TTFF. More accurate position may be obtained by GPS receivers due to the aiding as well.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular precise time delivery arrangement of the present invention.

FIG. 2 is a block diagram of one embodiment of the road side equipment of the arrangement of FIG. 1.

FIG. 3 is a block diagram of one embodiment of the on-board equipment of the arrangement of FIG. 1.

FIG. 4 is a block diagram of another embodiment of the on-board equipment of the arrangement of FIG. 1.

FIG. 5 is a block diagram of one embodiment of the present invention of an arrangement for delivering GPS aiding information to an OBU over a DSRC network.

### DETAILED DESCRIPTION OF THE PREFERRED EMBODIMENTS

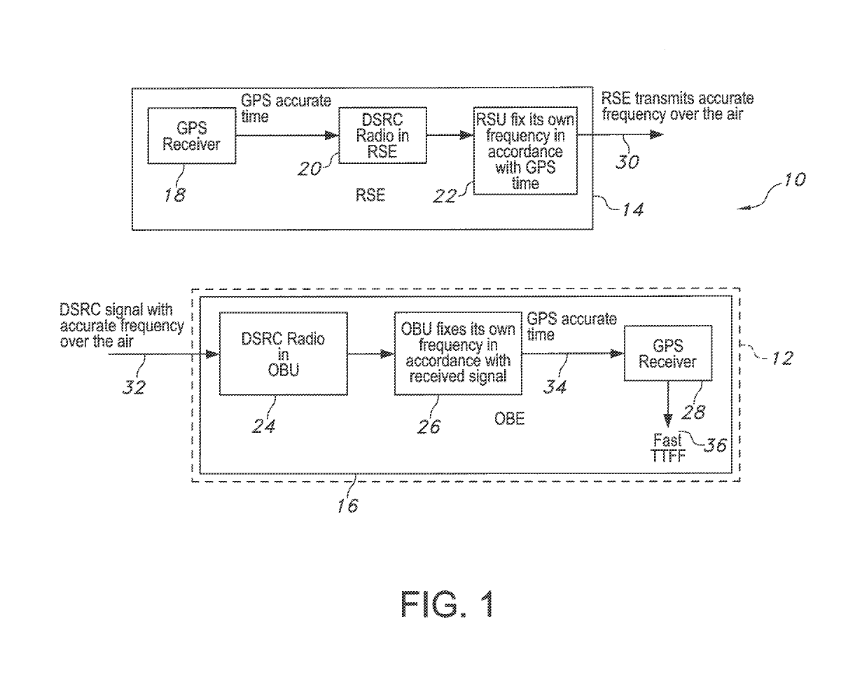

FIG. 1 illustrates one embodiment of a vehicular precise time delivery arrangement 10 of the present invention for a motor vehicle 12. Arrangement 10 includes road side equipment (RSE) 14 and on-board equipment (OBE) 16 disposed within vehicle 12. RSE 14 includes a road side unit (RSU) having a GPS receiver 18 and a DSRC radio 20. OBE 16 includes an on-board unit (OBU) having a DSRC radio 24 and a GPS receiver 28.

During use, GPS receiver 18 provides GPS accurate time to DSRC radio 20. At 22, the RSU may fix, modify or establish its own frequency in accordance with GPS time. The RSU may then transmit its own accurate frequency signal over the air, as indicated at 30. The airborne signal with an accurate frequency may be a DSRC signal that is compatible with DSRC radio 24, and may be received by DSRC radio 24, as indicated at 32. The OBU may fix, modify or establish its own frequency, as indicated at 26, in accordance with the accurate frequency received in the signal. The OBU may then transmit GPS accurate time to GPS receiver 28, as indicated at 34. Thus, GPS receiver 28 may achieve a fast time to first fix (TTFF), as indicated at 36. The above-described process of providing GPS receiver 28 with accurate time may have a time duration of ten seconds or less.

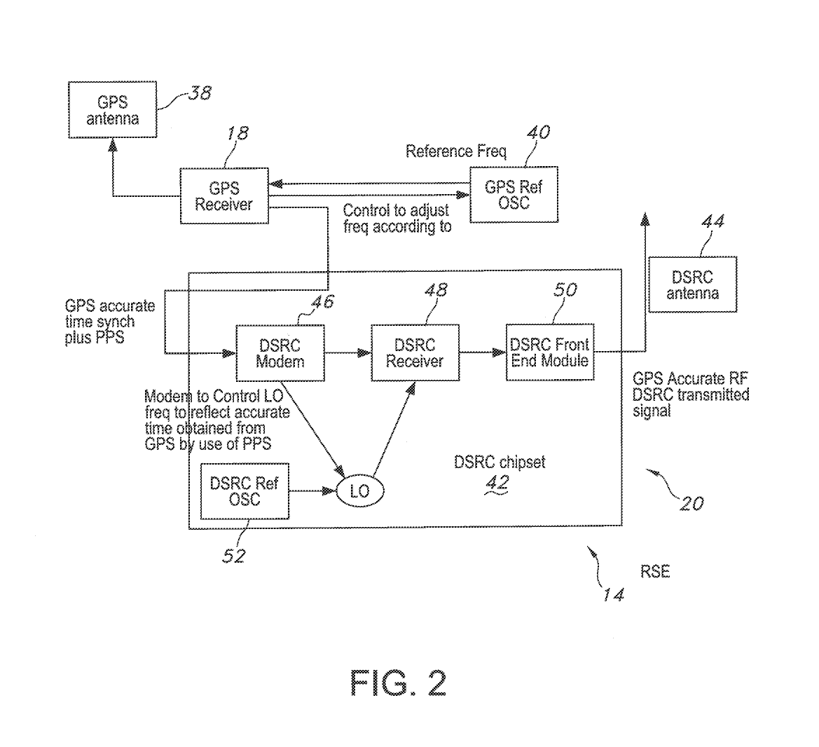

FIG. 2 illustrates one embodiment of road side equipment 14, including GPS receiver 18, DSRC radio 20, a GPS antenna 38, and a GPS reference oscillator 40. GPS receiver 18 communicates bi-directionally with reference oscillator 40, thereby providing a control mechanism to adjust frequency according to a reference frequency of oscillator 40.

DSRC radio 20 includes a DSRC chipset 42 and a DSRC antenna 44. DSRC chipset 42 includes a DSRC modem 46, a DSRC transceiver 48, a DSRC front end module 50, and a DSRC reference oscillator 52. Modem 46 may control LO frequency to reflect accurate time obtained from GPS by use of a pulse-per-second signal.

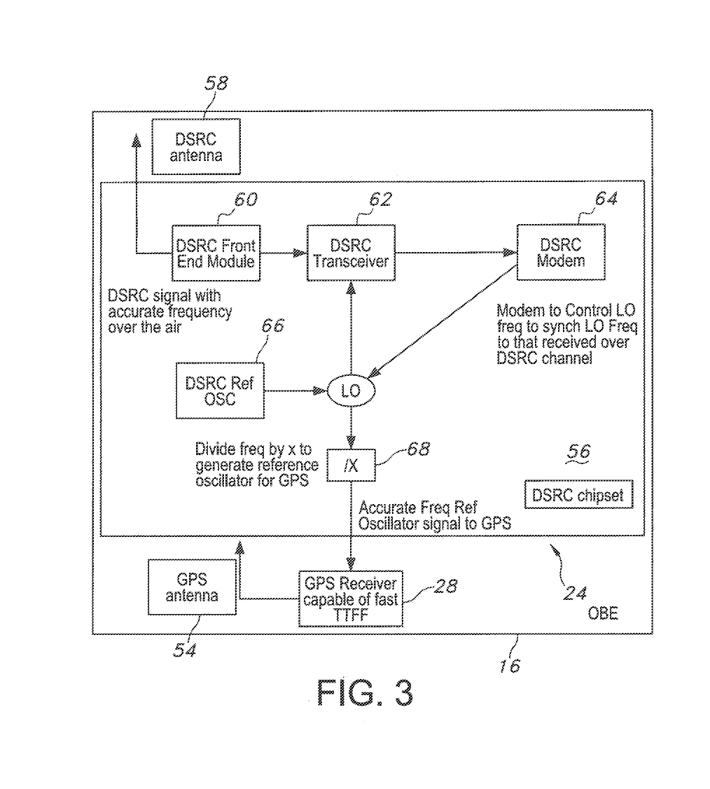

FIG. 3 illustrates one embodiment of on-board equipment 16 of arrangement 10 of FIG. 1. On-board equipment 16 includes DSRC radio 24, GPS receiver 28 and GPS antenna 54. DSRC radio 24 includes a DSRC chipset 56 and a DSRC antenna 58. DSRC chipset 56 includes a DSRC front end module 60, a DSRC transceiver 62, a DSRC modem 64, a DSRC reference oscillator 66 and a divider 68. DSRC antenna 58 transmits an airborne DSRC signal with accurate frequency.

Modem 64 may control the LO frequency to synchronize the LO frequency to the frequency received over the DSCR channel. Divider 68 may divide the LO frequency by x to generate a reference oscillator frequency for GPS. Thus, an accurate oscillator reference frequency signal may be transmitted to GPS.

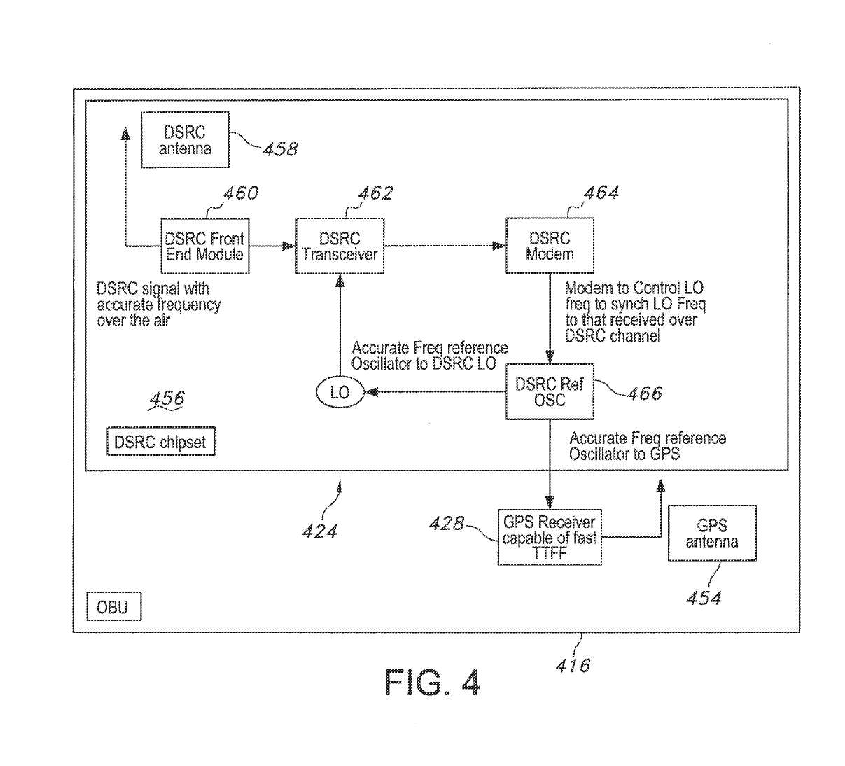

FIG. 4 illustrates another embodiment of on-board equipment 416, including a DSRC radio 424, a GPS receiver 428 and a GPS antenna 454. DSRC radio 424 includes a DSCR chipset 456 and a DSRC antenna 458. DSRC chipset 456 includes a DSRC front end module 460, a DSRC transceiver 462, a DSRC modem 464 and a DSRC reference oscillator 466. DSRC antenna 458 transmits an airborne DSRC signal with accurate frequency.

Modem 464 may control DSRC reference oscillator 466 to synchronize the LO frequency to the frequency received over the DSCR channel. The accurate oscillator reference frequency signal may be transmitted from oscillator 466 to both GPS receiver 428 and to DSRC LO.

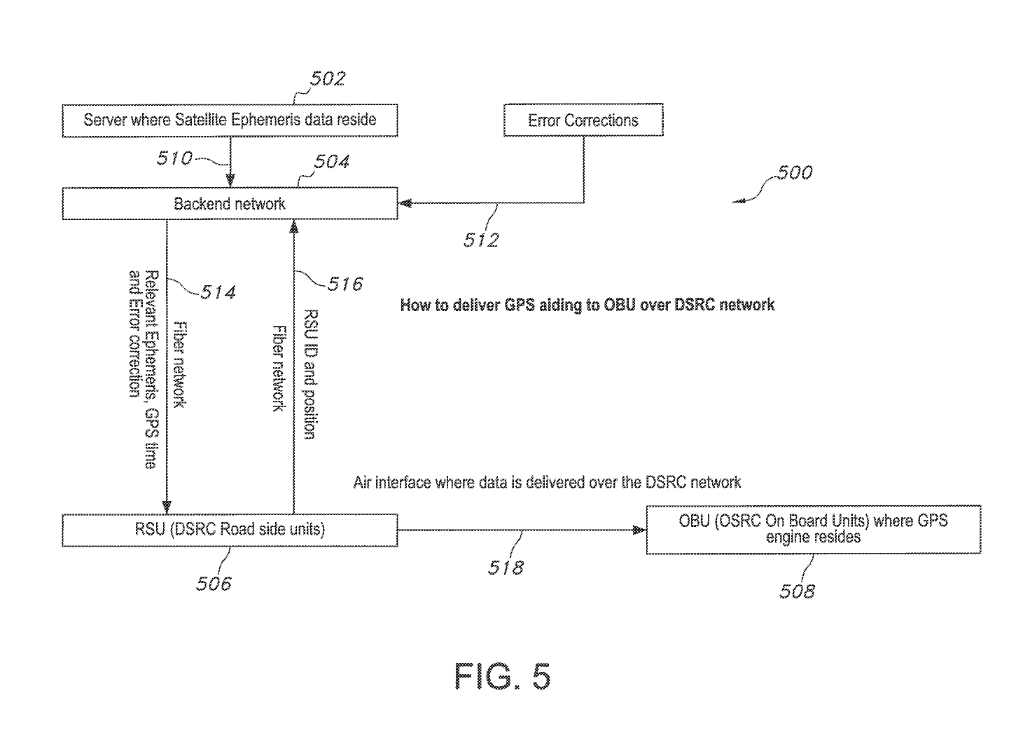

FIG. 5 illustrates one embodiment of the present invention of an arrangement 500 for delivering GPS aiding information to an OBU over a DSRC network. Arrangement 500 includes a server 502, a backend network 504, a DSRC road side unit (RSU) 506, and a DSRC on board unit (OBU) 508. Satellite Ephemeris data may reside in server 502. The satellite Ephemeris data may be transmitted to backend network 504, as indicated at 510. Error corrections are also transmitted to backend network 504, as indicated at 512. As indicated at 514, backend network 504 may transmit relevant Ephemeris data, GPS time, and error corrections to RSU 506 over a fiber network. This transmission may be in response to RSU 506 transmitting the RSU's identification information and position to backend network 504 over the fiber network, as indicated at 516. Finally, as indicated at 518, the GPS location aiding information may be delivered to OBU 508 from RSU 506 over the DSRC network and an air interface. The GPS engine may reside in the OBU 508.

Although DSRC radios are described herein as being included in the road side equipment and in the on-board equipment, it is to be understood that other types of radio frequency devices may be used instead of DSRC radios within the scope of the invention. For example, in all embodiments described above, each DSRC radio may be replaced by a respective C-V2X radio, and all corresponding DSRC hardware may be replaced by C-V2X hardware.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. On-board equipment for a motor vehicle, the on-board equipment comprising:
a radio configured to receive a signal from road side equipment, the signal having an accurate frequency in accordance with GPS time; and
a GPS receiver communicatively coupled to the radio, the on-board equipment being configured to determine the GPS accurate time and provide the GPS accurate time to the GPS receiver, the determining of the GPS accurate time being dependent upon the accurate frequency in the signal.

2. The on-board equipment of claim 1 wherein the radio comprises a DSRC radio.

3. The on-board equipment of claim 1 wherein the radio comprises a C-V2X radio.

4. The on-board equipment of claim 1 wherein the on-board unit and GPS receiver are configured to determine the GPS accurate time.

5. The on-board equipment of claim 1 further comprising an on-board unit including the radio and the GPS receiver, the on-board unit being configured to establish the frequency of the on-board unit by synchronizing the frequency of the on-board unit with the accurate frequency.

6. The on-board equipment of claim 5 wherein the on-board unit is configured to determine the GPS accurate time by synchronizing a time setting with the accurate frequency.

7. The on-board equipment of claim 1 wherein the radio is configured to provide the precise time to the GPS receiver.

8. A method of operating on-board equipment in a motor vehicle, the method comprising:
providing the on-board equipment with an on-board unit including a radio and a GPS receiver;
using the radio to receive a signal from road side equipment, the signal having an accurate frequency in accordance with GPS time;
using the on-board unit to establish a frequency of the on-board unit in accordance with the signal;
determining within the on-board equipment a GPS accurate time, the GPS accurate time being dependent upon the established frequency of the on-board unit; and
providing the GPS accurate time to the GPS receiver.

9. The method of claim 8 wherein the radio comprises a DSRC radio.

10. The method of claim 8 wherein the radio comprises a C-V2X radio.

11. The method of claim 8 wherein the GPS accurate time is determined.

12. The method of claim 8 wherein the on-board unit establishes the frequency of the on-board unit by synchronizing the frequency of the on-board unit with the accurate frequency.

13. The method of claim 8 wherein the on-board unit adjusts the GPS accurate time by synchronizing a time setting with the accurate frequency.

14. The method of claim 8 wherein the radio provides the precise time to the GPS receiver.

15. An arrangement for providing GPS accurate time in a motor vehicle, the arrangement comprising:
road side equipment including a road side unit, the road side unit having:
a first GPS receiver producing GPS accurate time; and
a first radio communicatively coupled to the first GPS receiver, the road side unit being configured to establish a frequency of the road side unit in accordance with the GPS accurate time, the road side equipment being configured to transmit a signal including an accurate frequency, the accurate frequency being dependent upon the established frequency of the road side unit; and
on-board equipment, the on-board equipment comprising:
a second radio configured to receive the signal from the road side equipment; and
a second GPS receiver communicatively coupled to the second radio, the on-board equipment being configured to determine the GPS accurate time and provide the GPS accurate time to the second GPS receiver, the determining of the GPS accurate time being dependent upon the accurate frequency in the signal.

16. The vehicle of claim 15 wherein the first radio comprises a first DSRC radio, and the second radio comprises a second DSRC radio.

17. The vehicle of claim 15 wherein the first radio comprises a first C-V2X radio, and the second radio comprises a second C-V2X radio.

18. The vehicle of claim 15 wherein the road side equipment and on-board equipment are configured to conjunctively perform the claimed functions in less than ten seconds.

19. The vehicle of claim 15 wherein the on-board unit is configured to establish the frequency of the on-board unit by synchronizing the frequency of the on-board unit with the accurate frequency.

20. The vehicle of claim 15 wherein the on-board unit is configured to determine the GPS accurate time by synchronizing a time setting with the accurate frequency.

21. The vehicle of claim 15 wherein the second radio is configured to provide the precise time to the second GPS receiver.

22. The vehicle of claim 15 wherein the road side unit is configured to establish the frequency of the road side unit by synchronizing the frequency of the road side unit dependent upon the GPS accurate time.

23. The vehicle of claim 15 wherein the road side unit is configured to establish the frequency of the road side unit by synchronizing a time setting with the GPS accurate time.

24. The vehicle of claim 15 wherein the first radio is configured to provide the GPS accurate time to the road side unit.
